(19) United States
(12) Patent Application Publication
(10) Pub. No.: US 2015/0220433 A1
(43) Pub. Date: Aug. 6, 2015

(54) METHOD FOR MANAGING FLASH MEMORIES HAVING MIXED MEMORY TYPES USING A FINELY GRANULATED ALLOCATION OF LOGICAL MEMORY ADDRESSES TO PHYSICAL MEMORY ADDRESSES

(71) Applicant: HYPERSTONE GMBH, KONSTANZ (DE)

(72) Inventor: FRANZ SCHMIDBERGER, KONSTANZ (DE)

(73) Assignee: HYPERSTONE GMBH, KONSTANZ (DE)

(21) Appl. No.: 14/264,426

(22) Filed: Apr. 29, 2014

(30) Foreign Application Priority Data
Jan. 31, 2014 (DE) 102014101185.6

(51) Int. Cl. G06F 12/02

(52) U.S. Cl. CPC G06F 12/0253; G06F 12/0246; G06F 2212/7205; G06F 2212/7211

(57) ABSTRACT

A method manages a flash memory for a computer system having flash chips divided into separately erasable physical memory blocks with a limited maximum erasure frequency. The memory blocks are divided into writable pages being subdivided into addressable subpages. The subpages are addressed by a computer via logical sector addresses being converted into physical subpage addresses. The flash memory has a first area containing single-level flash chips with a higher maximum erasure frequency, and a second area containing multi-level flash chips with a lower maximum erasure frequency. If write operations in the first area exceed an upper threshold for a filling level of written memory blocks, a written memory block having a low erasure counter is searched for in the first area, whose valid subpages are transferred into a memory block of the second area. The address allocations for the transferred subpages are updated.

### CROSS-REFERENCE TO RELATED APPLICATION

This application claims the priority, under 35 U.S.C. §119, of German application DE 10 2014 101 185.6, filed Jan. 31, 2014; the prior application is herewith incorporated by reference in its entirety.

### BACKGROUND OF THE INVENTION

### Field of the Invention

The present invention relates to a method for managing a flash memory for a computer system having multiple flash chips, which are divided into a plurality of separately erasable physical memory blocks. The memory blocks have a limited maximum erasure frequency and are divided into writable pages that in turn are subdivided into addressable subpages. The subpages are addressed by a computer system via logical sector addresses that are converted into physical subpage addresses via an address conversion structure.

The pages are made up of so-called subpages that are individually addressed and read, but which cannot be written individually. One or multiple sectors that were transferred from a host system with a logical sector address, also known as an LBA, are stored in subpages. These sectors are normally made up of 512 bytes and are the basic access unit of the large majority of computer systems. The physical subpages are addressed with the aid of physical page addresses that are ascertained via a hierarchical address conversion structure.

Two different types of flash chips are used in the flash memory. Single-level cell chips (SLC) provide a high number of possible write/erase cycles, but are relatively expensive. Multi-level cell chips (MLC) are substantially more economical, but provide a considerably lower number of possible write/erase cycles of the memory cells. The memory cells of the MLC flash chips are in principle configured identically to those of the SLC flash chips, but the prices for MLC flash chips are substantially lower per bit than those of the SLC flash chips.

It is obvious to use MLC flash chips in a mode in which only two states are differentiated per cell instead of four states. Thus, only one bit is stored, instead of the usual two bits per cell. As may be expected, such an operating mode is much more reliable than the standard two-bit mode. In the meantime, some flash chip manufacturers are providing the software-based configuration of MLC flash chips for this operating mode. The programming speed in this so-called SLC mode is comparable to that of the SLC flash chips. The number of possible write/erase cycles is approximately an entire order of magnitude higher compared to the two-bit mode. In addition to managing different types of flash chips (SLC and MLC), a hybrid memory management may also be used for different modes of the same flash memory (MLC in SLC mode and in generic two-bit mode). In order to maintain the simplicity of the description, a first area (SLC area) or a second area (MLC area) is referenced below. However, it is expressly pointed out that in the first area, instead of SLC flash chips, MLC flash chips may also be used in SLC mode or even in a pseudo-SLC mode, in which only one bit per cell is stored as well. The second area is then made up of the same MLC flash chips, which, however, are operated in the generic two-bit mode. The first area may also be populated with memory chips of a different technology, for example, PCM (phase change memory), if they are capable of being operated with a NAND interface and have correspondingly good write/erase characteristics.

When using a flash memory in a computer system, some data are modified frequently, while other data, for example, application programs, are overwritten very infrequently. Thus, it is desirable to store the infrequently modified data in the inexpensive flash chips and to reserve the expensive flash chips preferably for the frequently modified data.

Wear-leveling methods are used in flash memories in order to achieve an equal distribution of the required write/erase cycles to all memory blocks and thus to maximize the lifetime of the flash memory.

For this purpose, a conversion of logical sector addresses into physical subpage addresses is carried out via an address allocation structure, and this allocation is changed according to the erasure frequency of the memory blocks.

### SUMMARY OF THE INVENTION

The object of the present invention is to disclose a method that allows combining two types of flash chips having a different maximum number of possible write/erase cycles in one flash memory, thus achieving a maximum lifetime of the flash memory. The data stored in the MLC area are to be written reliably, and a writing performance similar to that of SLC flash chips is to be achieved, even if the flash memory is primarily made up of MLC flash chips.

The method described here is an extension of European patent EP 2 401 680 B1 (corresponding to U.S. patent publication No. 20110302359), on which a block-based allocation method as an addressing method is based.

Here, a finely granulated address conversion structure is used on a subpage basis, as described in published, non-prosecuted German patent application DE 10 2014 100 800.6. For today's typically very large memory blocks, such an address conversion structure is more suitable than the previously frequently used block-based addressing method.

The flash memory contains a memory controller having firmware in which the method is carried out. All flash chips of the flash memory are connected to the controller via a memory bus and are managed by it. The flash memory is divided into two areas, the first area being equipped with the single-level cell chips (SLC), while the second area contains the multi-level cell chips (MLC). The size of the second area is typically a multiple of the first area; however, all ratios are possible. The sizes of the separately erasable real memory blocks may be different in the two flash types.

The address conversion structure is empty in a newly manufactured flash memory. The elementary access units of the computer system are sectors of 512 contiguous bytes. The host-side addresses used for such sectors are identified using a logical sector address (LBA). In the address conversion structure, a physical memory address is dynamically allocated to each logical sector address (LBA) if it is accessed for writing. A physical address that points to a physical memory range, known as a subpage, is advantageously allocated to a group of a few contiguous logical sector addresses. A subpage is formed from an integer fraction of the sectors contained in a page. The address of an individual sector contained in a subpage results from the physical subpage address (PBA), to which the relative sector number is added within the subpage. If the entire page is used as a minimal addressing unit, this constitutes the special case of the fraction 1/1. The host computer system uses the logical sector addresses (LBAs) completely randomly.

Example: A page size of 8 kB corresponds to 16 sectors per page. Possible subpage sizes would then be 1, 2, 4, 8 or 16 sectors per page. The use of subpages for addressing accelerates the random writing of write units with a number of sectors that is smaller than the page size.

The method provides that all write operations that are triggered directly by the computer system via write commands take place in the first area of the flash memory. Read commands may involve the first area as well as the second area.

The above-cited address-mapping method uses so-called over-provisioning. Over-provisioning means that the memory capacity provided for user data is lower than the actual existing capacity of the memory, for example, by 10%. The over-provisioning is required so that it is always possible to provide enough memory blocks for writing.

Example: a flash memory is configured having an 8 GB SLC first area and a 16 GB MLC second area. With over-provisioning of 12.5%, the net remainder for storage of useful data is then 7 GB in the first area and 14 GB in the second area. A maximum of 2*7*2̂20 sectors may be stored into the 7 GB useful data area with a different LBA. This number corresponds to a filling level of 100% of the first area.

To control the distribution of the useful data across the two first and second areas, relative threshold values are defined, namely, the threshold value S_{S,u} as the lower threshold of the SLC filling level, and the threshold value S_{S,o} as the upper threshold of the SLC filling level (S_{X,u}, for example, 95% and S_{X,o}, for example, 100%). Correspondingly, the threshold value S_{M,u} is defined as the lower threshold of the MLC filling level, and the threshold value S_{M,o} is defined as the upper threshold of the MLC filling level. Furthermore, a filling level counter F_{S} is defined for the filling level of the first area, and a filling level counter F_{M} is defined for the filling level of the second area. The parameter BEC_{avg,S} denotes the average number of erasures per memory block rounded to integer values in the first area, and the parameter BEC_{avg,M} denotes the average number of erasures per memory block rounded to integer values in the second area.

The block erase multiplier BEM is the ratio of maximum permissible erasure frequencies in the first area to maximum permissible erasure frequencies in the second area. This will normally be in the order of magnitude of 30-40 if the first area is configured from SLC flash chips, and at approximately 10-20 if the first area is configured using MLC flash chips in the SLC operating mode. However, the values from the respective flash data sheets are authoritative.

A so-called garbage collection searches in the flash memory for obsolete memory blocks whose content is no longer current and submits them to an erase operation. Afterwards, they are then available for new write operations.

A garbage collection is started for the first area if a predefined proportion of erasable memory blocks b_{S,obsolete} is reached or undershot.

A static garbage collection for the purpose of wear leveling is carried in the second area as long as BEC_{avg,S} is smaller than BEM*BEC_{avg,M} and the filling level F_{M} is smaller than the threshold value S_{M,o}.

A garbage collection during the generation of new, writable obsolete memory blocks is carried out within the first area as long as the filling level F_{S} is smaller than the threshold value S_{S,o}. If the threshold value S_{S,o} is reached or exceeded, valid pages are moved during the garbage collection into a memory block of the second area until the filling level F_{S} has fallen again below the threshold value S_{S,u}.

It is thus ensured that the first area does not overflow. If no memory blocks having a very large obsolete counter are available, memory blocks having the smallest possible erasure counter are used as source blocks for the garbage collection. The threshold S_{S,u} must not be set too low in order to avoid an overflow of the second area.

The second area is likewise subject to the static garbage collection, which is started if the proportion of erasable memory blocks b_{M,obsolete} (minimum number of obsolete or unused memory blocks in the second area) is reached or undershot, or if memory blocks of the second area are flagged for wear leveling.

The free memory blocks created by the wear leveling are primarily removed from the buffer pool during the preparation of writable memory blocks. Such memory blocks are easily found via the attribute W_{min,o} (minimum wear level class of obsolete memory blocks in the address structure for the management of physical memory blocks). A wear leveling operation is triggered if the erase operation of a memory block resulted in a change of the wear level class of this memory block, and there is at least one block among the memory blocks that are not completely obsolete having a low wear level class at a minimum wear level distance (for example, 2). Generally, such a memory block selected for exchange will contain some obsolete pages, i.e., will contain data that are not sufficiently valid for completely writing to the memory block to be exchanged. If multiple possible exchange blocks exist, the nearest one is used. Correspondingly, an exchange block that is not completely freed up is copied further into the next memory block flagged for the wear leveling, if one still exists.

A further aspect of the method is that a filling level and an upper threshold value are defined for the second area, and a garbage collection in the first area having a target block in the second area is started for the purpose of the wear leveling only if the filling level is smaller than the upper threshold value. Overflowing of the second area is thus avoided, even for write operations of the host system that are not highly localized.

One important aspect of the method, carrying out direct writing of useful data only in the first area, is the reliable writing of data in the second area as well. In particular, MLC memories have the characteristic that when programming a so-called “weak” page, the data of the associated “strong” page are invalid until the programming operation has been successfully completed, and thus, in addition to the data currently to be written, data from an earlier write operation may also be lost if an unanticipated power outage occurs. The previous data of the page that is also destroyed are generally no longer present; however, the data of the current page are present. The data integrity is ensured by pages having source data that were copied into a strong page being set obsolete during the garbage collection only if the associated weak page was successfully programmed.

Other features which are considered as characteristic for the invention are set forth in the appended claims.

Although the invention is illustrated and described herein as embodied in a method for managing flash memories having mixed memory types using a finely granulated allocation of logical memory addresses to physical memory addresses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings (examples).

### BRIEF DESCRIPTION OF THE SEVERAL VIEWS OF THE DRAWING

FIG. 1 is a block diagram of a flash memory system according to the invention;

FIG. 2 is an illustration showing an address allocation to areas in the flash memory; and

FIG. 3 is an illustration showing the flash memory having filling level indicators and threshold values.

### DETAILED DESCRIPTION OF THE INVENTION

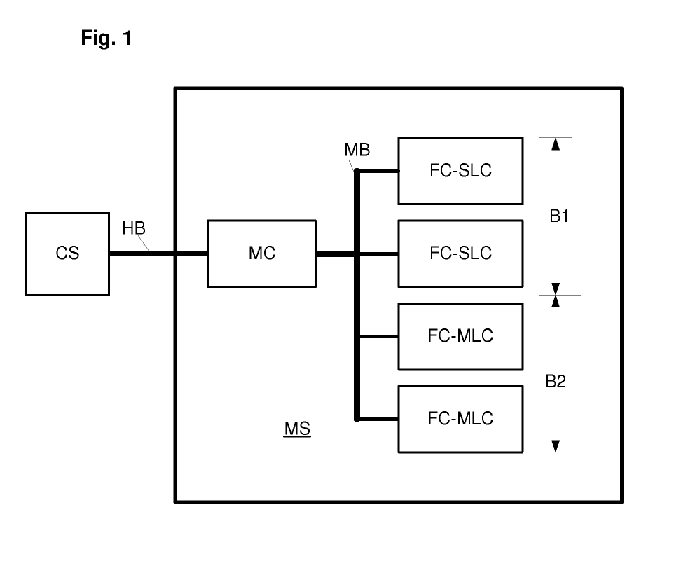

Referring now to the figures of the drawings in detail and first, particularly to FIG. 1 thereof, there is shown a flash memory MS having a memory controller MC, which is connected via a computer bus HB to a controlling computer system CS. Flash chips FC that form the data memory are connected to the memory controller MC via a memory bus MB. Two types of flash chips FC are present, SLC chips FC-SLC being allocated to a first area B1 and MLC chips FC-MLC being allocated to a second area B2. The SLC chips FC-SLC have a substantially higher maximum erasure potential compared to the MLC chips FC-MLC.

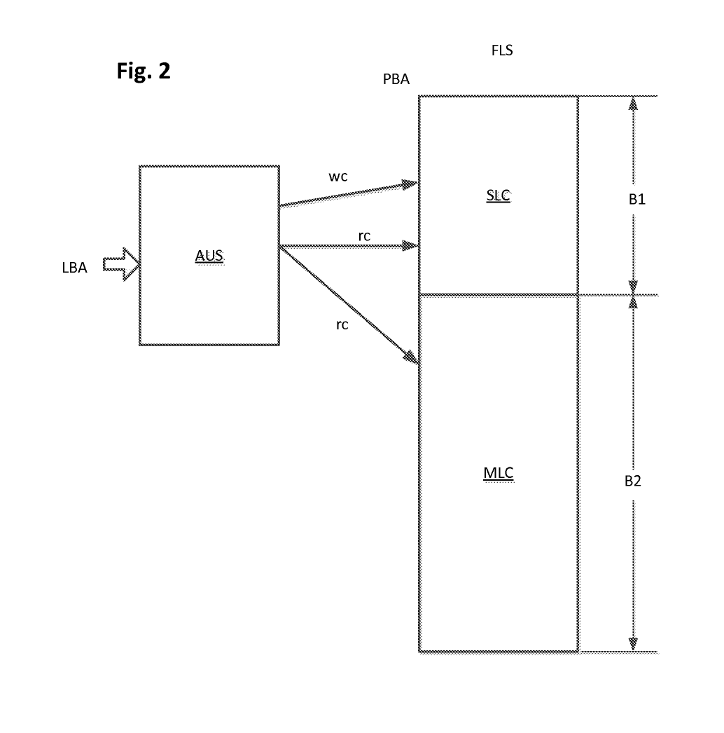

FIG. 2 shows an address conversion structure AUS and the flash memory MS having the two areas B1 and B2. A logical sector address LBA predefined by the computer system is converted into an associated physical (sub)page address PBA. Write operations we are carried out only on area B1, while read operations re are applied to both areas.

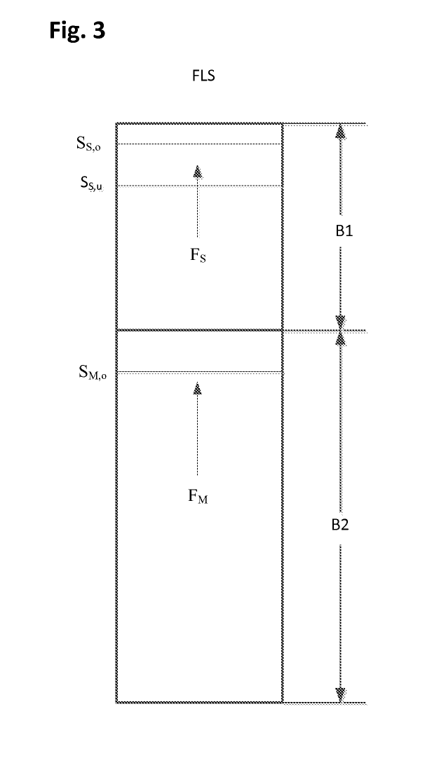

FIG. 3 shows the flash memory MS with its two areas B1 and B2. For area B1, an upper threshold value and a lower threshold value are defined for the filling level, which are relevant to garbage collection.

For area B2, an upper threshold value is defined for the filling level, which is relevant to the garbage collection and the wear leveling in area B2.

The following is a summary list of reference numerals and the corresponding structure used in the above description of the invention:
A, B, C, X Physical memory blocks
AUS Address conversion structure
B1 First area
B2 Second area
BEC_{avg,S} Average number of erasures per memory block in the SLC area
BEC_{avg,M} Average number of erasures per memory block in the MLC area
BEM Block erase multiplier
b_{S,obsolete} Minimum number of obsolete memory blocks in area B1
b_{M,obsolete} Minimum number of obsolete memory blocks in area B2
CS Computer system
EC Erasure counter
F_{M} Filling level—area B1
F_{S} Filling level—area B2
FC Flash chip
MS Flash memory
HB Computer bus
LBA Logical sector address
MB Memory bus
MC Memory controller
MLC Multi-level cell memory
PBA Physical subpage address
SLC Single-level cell memory

S_{M,o} Upper threshold—MLC filling level
S_{M,u} Lower threshold—MLC filling level
S_{S,o} Upper threshold—SLC filling level
S_{S,u} Lower threshold—SLC filling level
WLC Wear-level class

1. A method for managing a flash memory for a computer system having multiple flash chips divided into a plurality of separately erasable physical memory blocks, the memory blocks have a limited maximum erasure frequency, which comprises the steps of:
dividing the memory blocks into writable pages that in turn are subdivided into addressable subpages, and addressing the addressable subpages by a computer system via logical sector addresses converted into physical subpage addresses via an address conversion structure;
providing the flash memory with two areas having different types of the flash chips including a first area containing single-level flash chips having a higher maximum erasure frequency and a second area containing multi-level flash chips having a lower maximum erasure frequency;
counting a number of erasures carried out in an erasure counter for each of the memory blocks, and when writing to the flash memory, an address conversion of the logical sector addresses into the physical subpage addresses is carried out such that sectors are written to in the addressable subpages of the memory blocks of the first area;
searching for a written memory block having a low erasure counter during a garbage collection in the first area whose valid subpages are transferred into a memory block of the second area, if so many write operations have been carried out in the first area that an upper threshold value for a filling level of written memory blocks in the first area is now reached;
updating address allocations for transferred subpages; and
erasing the memory block of the first area and providing the memory block erased as a buffer block for further write operations.

2. The method according to claim 1, which further comprises carrying out the address conversion from the logical sector addresses into the logical subpage addresses via a finely granulated address conversion structure.

3. The method according to claim 1, wherein the garbage collection in the first area is started if the filling level is above the upper threshold value, and valid subpages are then moved into the memory blocks of the second area until the filling level has fallen again below a lower threshold value.

4. The method according to claim 1, which further comprises defining a further filling level and a further upper threshold value for the second area, and the garbage collection in the first area having a target block in the second area is started for a purpose of a wear leveling only if the further filling level is smaller than the further upper threshold value.

5. The method according to claim 1, which further comprises defining an average number of erasures per memory block in the first area and an average number of erasures per memory block in the second area.

6. The method according to claim 5, which further comprises determining the upper threshold value and a lower threshold value such that average erasure frequencies result for the first area and for the second area during an operation of the flash memory, which are at a ratio to one another that corresponds to a ratio of their maximum erasure frequencies.

7. The method according to claim 1, wherein the garbage collection is started for the first area if a predefined proportion of erasable memory blocks is reached or undershot.

8. The method according to claim 1, which further comprises starting the garbage collection for the second area if a predefined proportion of erasable memory blocks is reached or undershot.

9. The method according to claim 1, which further comprises defining wear level classes for the memory blocks of both the first and second areas, which each correspond to an area of erasure counter levels, and a wear leveling operation is triggered if an erase operation of a memory block resulted in a change of a wearing level class of the memory block, and there is at least one memory block among the memory blocks that are not completely obsolete having a lower wear level class.

10. The method according to claim 1, wherein if the flash chips having strong and weak pages are present in the second area, the pages having data that were copied into the strong page are set obsolete during the garbage collection only if an associated weak page was successfully programmed.
